(19) United States
(12) Patent Application Publication
(10) Pub. No.: US 2005/0064147 A1
(43) Pub. Date: Mar. 24, 2005

(54) Adhesive binder strips having reduced transverse curl and method

(76) Inventors: Stefan J. Rublowsky, Albany, CA (US); Jerome D. Olson, Oakland, CA (US); Eugene E. Anderson, Berkeley, CA (US)

Correspondence Address: Philip A. Girard;GIRARD & EQUITZ LLP, Suite 1110, 400 Montgomery Street, San Francisco, CA, 94104, US

(21) Appl. No.: 10/668,058

(22) Filed: Sep. 19, 2003

(51) Int. Cl. B32B 3/00

(52) U.S. Cl. 428/167

(57) ABSTRACT

An adhesive binder strip having reduced transverse curl and method of manufacture. An elongated substrate is provided and a layer of molten, heat-activated adhesive is applied over the substrate surface. The layer of molten adhesive is permitted to cool so that the layer is in a solid state. The surface of the cooled adhesive is then mechanically deformed such as by cutting a multiplicity of grooves in the surface. The number and depth of the grooves are selected so as to achieve a substantial reduction in the amount of curl present in the binder strip. Once the mechanical deformations have been made, the binder strip can be used to bind a stack of sheets.

### BACKGROUND OF THE INVENTION

1. Field of the Invention

The present invention relates generally to the field of book binding and, in particular, to adhesive binder strips having reduced transverse curl.

2. Description of Related Art

Adhesive binder strips for binding stacks of sheets, typically using desktop binding equipment, are well known in the art. By way of example, U.S. Pat No. 4,496,617 discloses a binder strip similar to the binder strip 20 shown in FIGS. 1A and 1B. The prior art binder strip 20 includes an elongated substrate 22 having a width that exceeds the thickness of the stack of sheets to be bound and a length that corresponds to the length of the edge of the stack. For example, if a stack of 8 ½ by 11 inch sheets is to be bound, then the substrate would be 11 inches long, assuming that the stack is to be bound along the 11 inch edge of the stack. A central band of low tack, low viscosity heat-activated thermoplastic adhesive 24 is disposed on the surface of substrate 22 and extends substantially along the full length of the substrate 22. Adhesive band 24 stops just short of the two ends of the substrate 22 so as to provide an adhesive gap at each end where the underlying substrate is exposed. Adhesive band 24 should be at least as wide as the thickness of the stack to be bound. Typically, the binder strips are available in narrow, medium and wide widths, where the width of the central adhesive band 24 is adjusted, together with the substrate 22 width, to accommodate stacks of varying thickness. An adhesive sold by H. B. Fuller of St. Paul, Minn. under the designation HM-1330 is a typical adhesive for this application. Binder strip 20 further includes a pair of outer adhesive layers 26A and 26B made of a relatively high tack, high viscosity heat activated thermoplastic adhesive. An adhesive sold by H. B. Fuller under the designation HM-1777 is a typical adhesive for this application. The typical width of the center adhesive band 24 for narrow, medium and wide binder strips is 0.66, 1.16 and 1.66 inches respectively, with the width of the outer adhesive bands 26A and 26B being fixed at 0.23 inches.

The binder strip 20 may be used to bind a stack of sheets using a desktop binding machine such as disclosed in U.S. Pat. No. 5,052.873. In operation, the user inserts the stack to be bound in the binding machine, with the machine securing the stack. Next, the user inserts a binder strip of appropriate width and length into the machine. The strip and stack are then manipulated so that the binder strip is applied to the stack 28 as shown in FIG. 1C using heat and pressure. The two high tack, high viscosity bands 26A and 26B operate to secure the substrate 22 to the front and back cover sheets. The low tack, low viscosity central adhesive band 24 operates to secure the edges of the individual sheets together and to the substrate.

It has been found that the prior art binder strips of the general type shown in FIGS. 1A, 1B and 1C have a tendency to curl around the transverse axis of the binder strip as shown in FIG. 3. The curling is around the surface 30A that carries the heat activated adhesive band. During manufacture of the binder strips, the adhesives 24, 26A and 26B are applied to the substrate 22 surface in molten form. Once the adhesives have solidified due to cooling, the binder strips tend to curl in the manner shown in FIG. 3. The line X represents the chord between two selected points 32A and 32B on the binder strip 30, with the line being orthogonal to the longitudinal axis to the strip, that is, being along the transverse axis. Distance H represents the maximum distance between the adhesive surface 30A and line X. If the curl is symmetrical, distance H is measured from the center of the strip 32C, but that would not necessarily be the case. The curling becomes more pronounced over a period of time, sometimes over a few days, and can present problems during the binding process as described below.

In some manufacturing processes, the substrates are coated with the adhesives when the substrates are in web form, that is, when the substrates are uncut. After application of the adhesives to appropriate portions of the substrate web, the adhesives are permitted to cool and thereby harden to some degree. The individual binder strips are then cut from the web. Frequently, the web is cut in such a way so as to produce a roll of continuous binder strips. This roll can then be cut into individual binder strips either at the factory or by the end user. It has been found that the binder strips do not curl significantly when in roll form. However, once the strips are unrolled, the strips will then tend to curl over a relatively short period of time. Some binding machines operate using binder strips in roll form and function to cut the strips to the desired length during the binding process. In that case, binder strips tend to remain flat for a sufficient time to complete the binding process. Thus, curling is not a problem in such cases. Further, some binding machines, including the machine disclosed in U.S. Pat. No. 5,052,873 noted above, have sophisticated binder strip handling features, which generally avoid problems relating to binder strip curling. However, curling can be a problem with less complex, and thus less costly, binding machines.

FIGS. 2A, 2B, 2C and 2D depict another variety of prior art adhesive binder strip 34, similar to that disclosed in U.S. Pat. No. 6,056,493. Binder strip 34 includes a substrate 36 with a heat activated adhesive matrix disposed on the surface, extending substantially the full length of the substrate. The matrix includes a first, relatively wide adhesive band 38A made of low tack, low viscosity heat activated adhesive similar to the adhesive type used for adhesive band 25 of binder strip 20. A relatively narrow band 38B of the low tack, low viscosity heat activated adhesive is disposed along the length of the strip, separated from the wide band by a gap 40. As will be explained, the adhesive gap 40 allows the strip to be easily folded in the location of the gap. Two bands 42A and 42B of high tack, high viscosity adhesive are disposed along the outer edges of the binder strip 34, the same type of adhesive used in adhesive bands 26A and 26B of binder strip 20.

In order to bind a stack of sheets 28, binder strip 34 is first manually folded along gap 40 to form an L-shaped cross-section as shown in FIG. 2C. The fold divides the substrate into a section 36A and a section 36B. Typically, two widths of binder strips are available, with the width of substrate section 36A being varied along with the width of adhesive 38A, with the adhesive width being typically 0.57 and 1.08 inches for the respective narrow and medium widths. The width of adhesive 38A should be at least as great as the width of the stack 28 being bound. In some cases, the fold may be pre-formed by the strip manufacturer.

The folded strip 34 is then positioned in a binding machine of the type disclosed in U.S. Pat. No. 6,056,493 referenced above. The strip is positioned so that substrate section 36B is vertical and section 36A is horizontal. The user then positions the stack 28 to be bound into the binding machine, with the edge of the stack resting over substrate section 36A. One corner of the stack edge is abutting gap 40 of the strip, with adhesive bands 38B and 42B contacting an end sheet (cover) of stack 28. A heated platen is applied to both substrate sections 36B and 36A to as to commence heating of the associated adhesives. Once adhesives 38A and 42A have become somewhat softened by the heating, a movable platen operates to fold that part of substrate section 36A extending past the edge of the stack. That would include that part of the section 36A carrying all of adhesive 42A and perhaps part of adhesive 38A, depending upon the thickness of the stack 28. The preheating of the adhesive facilitates folding of the substrate section 36A. The two high tack adhesive bands 42A and 42B cause the substrate 36 to be secured to the front and back cover sheets of the stack 28. The low viscosity adhesive 38A causes the ends of the individual sheets of the stack to be bound together and to the substrate. Low tack, low viscosity adhesive band 38B functions to ensure that the ends of sheets of the stack 28 near gap 40 receive sufficient adhesive to form a reliable bond for those sheets.

Although the binding machine disclosed in U.S. Pat. No. 6,056,493 is less complicated than the machine disclosed in U.S. Pat. No. 5,052,873, the machine provides less support for binder strip 34 during binding. Thus, if the binder strip 34 has substantial curl, particularly in the region of substrate section 36A, the interface between the end of the stack and the substrate will not be flat, as desired. Instead, there will be a tendency for the individual sheets of the stack to go out of alignment with one another so as to conform to the curved substrate. The result is a bound book with the exposed sheets being out of alignment, appearing as if the stack had not be properly jogged prior to binding. Even worse, the curl may cause only part of the lower surface of the binding strip to have good contact with the heating surface of the binding machine. That is detrimental to the binding process, because those portions not in good contact with the heated surface will not have the adhesive melted sufficiently to adequately flow around and between the sheets, so that these sheets will not be adequately secured.

There is a need for an adhesive binding strip that has substantially reduced transverse curl. Such strips can be reliably used in all types of binding machines, including machines with less sophisticated binder strip handling mechanisms and machines that receive individual strips, as opposed to strips in roll form. The present invention meets these requirements with only a minimum increase in cost of manufacture. These and other advantages of the present invention will become apparent to those skilled in the art upon a reading of the following Detailed Description of the Invention together drawings.

### SUMMARY OF THE INVENTION

An adhesive binder strip having reduced transverse curl and method of manufacture are disclosed. It has been found that, in some applications, such transverse curl can interfere with proper binding. An elongated substrate is provided having a longitudinal axis and a transverse axis normal to the longitudinal axis. A layer of molten, heat-activated adhesive is applied over a surface of the substrate. The adhesive layer may be comprised of both low and high viscosity adhesives. The layer of molten adhesive is permitted to cool so that the layer is in a solid state. The temperature at which the adhesive reaches the solid state is defined herein as the temperature determined by the standard Mettler Cup and Ball Softening Point test.

Subsequent to the cooling, the surface of the adhesive is mechanically deformed. The nature of the mechanical deformation is such that transverse curl in the binder strip is substantially reduced. Substantial reduction is based upon the amount of curl that would otherwise be present in the binder strip but for the mechanical deformation. The mechanical deformation may be accomplished, by way of example, by forming a multiplicity of grooves in the adhesive, having a depth and frequency such that the substantial reduction in curl is achieved. Once the mechanical deformations have been made, the binder strip can be used to bind a stack of sheets.

### BRIEF DESCRIPTION OF THE DRAWINGS

FIGS. 1A and 1B are respective plan and elevational views of one type of conventional adhesive binder strip.

FIG. 1C is a elevational view of a portion of a stack of sheets bound using the binder strip of FIGS. 1A and 1B.

FIGS. 2A, 2B and 2C are respective plan, elevational and elevational views of a second type of conventional adhesive binder strip.

FIG. 2D is a elevational view of a portion of a stack of sheets bound using the binder strip of FIGS. 2A, 2B and 2C.

FIG. 3 depicts a cross-section of a conventional binder strip, showing transverse curl.

FIG. 4 is a plan view of an adhesive binder strips in accordance with one embodiment of the present invention.

FIG. 5 is a cross-sectional view of the FIG. 4 binder strip taken though section line 5-5 showing details of the mechanical deformation of the center adhesive of the binder strip.

FIGS. 6A-6C are plan views of adhesive binder strips in accordance with further embodiments of the present invention.

FIG. 7 is a flow chart depicting the subject method of reducing transverse curl.

### DETAILED DESCRIPTION OF THE INVENTION

The present invention reduces the transverse curl in a binder strip by mechanically deforming the exposed adhesive surface of the binder strip. The mechanical deformations are made after binder strip adhesive, which is applied to the substrate in molten form, has had an opportunity to cool so that the adhesive has changed from substantially a liquid to substantially a solid state. The thermoplastic adhesive material is of a nature that it doesn't transition from fully liquid to fully solid at a single temperature, instead gradually becoming more and more viscous as its temperature lowers until it has an essentially solid character. The temperature at which the adhesive changes to a solid state can be defined by the “Mettler Cup and Ball Softening Point” test as described in the ASTM standard D6090. For purposes of the present application, the adhesive has changed to the solid state when the temperature has reached the Mettler Cup and Ball Softening Point (hereinafter “Mettler Softening Point”) for the adhesive. Thus, for example, for a common adhesive used in binder strip applications having a Mettler Softening Point temperature of 158 degrees F., the mechanical deformations should not be made until the adhesive has cooled to 158 degrees F., or less. It should be noted that in practice the adhesive could be somewhat above that temperature just prior to entering the mechanical deforming process, and could be cooled to the Mettler Softening Point during the process itself.

The mechanical deformations can be made immediately after sufficient cooling, or the strip may be cooled sufficiently to be rolled and allowed to cool on the roll for a longer period of several hours or more, so that the temperature is well below the required point and the adhesive is even more substantially solid. Then the strip is unrolled and the mechanical deformations are applied.

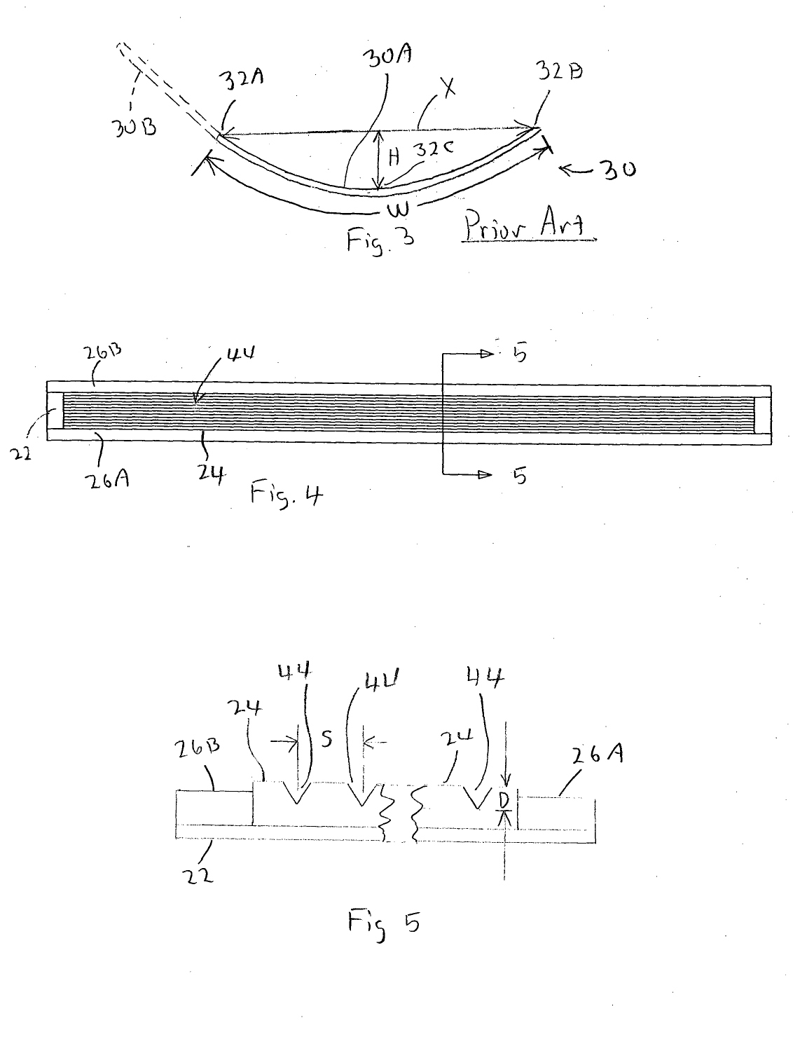

The mechanical deformation may be carried out in a variety of ways. One technique is to provide a series of grooves 44, as shown in FIGS. 4 and 5, that are generally along the longitudinal axis of the binder strip. It has been found that the grooves need only be applied to the central adhesive band 24 in order to effectively reduce the curl. In the FIG. 4 embodiment, the grooves have a spacing S of 0.030 inches over the width of the adhesive band 24, although the spacing may be increased up to 0.150 inches. The groove depth D is preferably determined by the thickness of the adhesive. The depth should be at least 20% of the thickness of the adhesive, and preferably from 30% to 100% of the adhesive thickness. In some cases, a relatively thin undercoat adhesive may be used under the central adhesive 24. One purpose of the undercoat adhesive is to act as a barrier so as to reduce the tendency of the low viscosity adhesive to penetrate the substrate and to leave a residue that is visible through the substrate. When determining the depth D, the total thickness of the adhesive where the groove 44 is formed should be taken into account, including the thickness of any undercoat adhesive. Further, placing the grooves closer together, that is, reducing the value of S, permits the value of D to be reduced for the same reduction in curl.

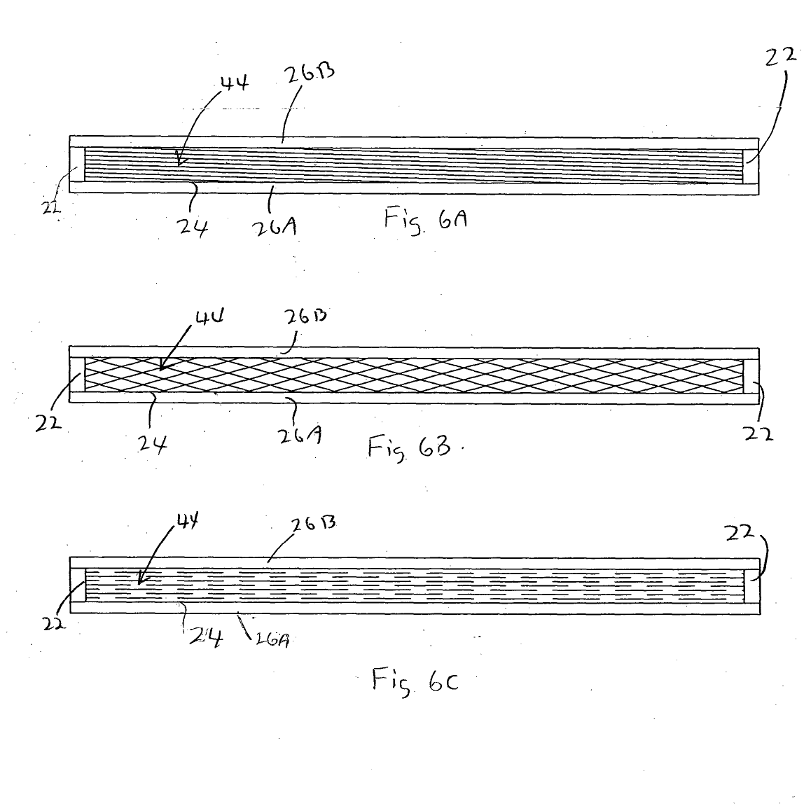

Grooves 44 can be created in various manners, although it has been found that using conventional rotary slitting knives with a blade angle of 45 degrees and an edge radius of 0.005 inches is satisfactory. The grooves 44 need not be aligned exactly with the longitudinal axis of the binder strip and can vary as much as 10 degrees from longitudinal without a noticeable reduction in effect. This approach is depicted in FIG. 6A where the grooves are shown formed at an angle with respect to the longitudinal axis of the strip. A further approach is shown in FIG. 6B where the grooves are laid out in a crisscrossing arrangement, again with the grooves 44 being at an angle with respect to the longitudinal axis. A still further approach is depicted in FIG. 6C where grooves 44 are formed along the longitudinal axis, with continuous grooves alternating with broken grooves.

Although grooves 44 can be formed using a rotary slitting knife as noted above, the grooves can also be formed using a razor sharp instrument, such as a utility knife. A tool carrying multiple razor sharp cutting edges could be used form this purpose. In that event, the resultant grooves are narrow and are not necessarily open visibly on the surface of the adhesive. The grooves can also be laid out in a sinusoidal manner rather than being linear. The mechanical deformations can also be in the form of individual punctures made in the adhesive surface as would be created by an awl. Again, a tool carrying multiple awl shaped points could be used to create the punctures. The cross-section of the punctures, as viewed from the adhesive surface, could be circular or of other geometry.

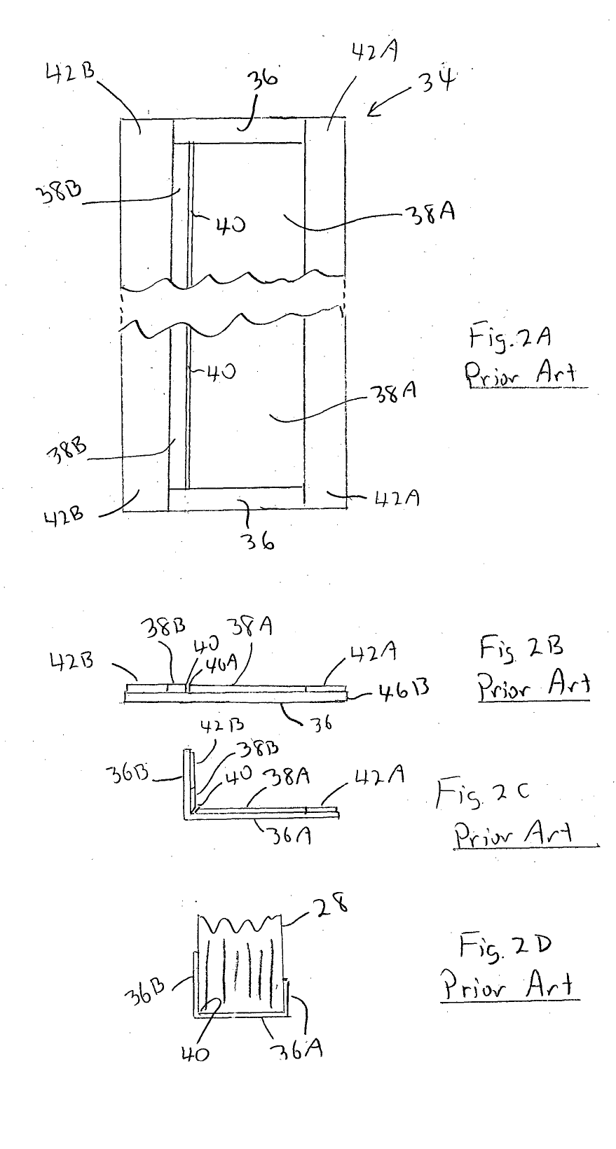

In order to address transverse curl in adhesive binder strips 34 of the type depicted in FIGS. 2A, 2B and 2C, it has been found that satisfactory results can be achieved by applying the same mechanical deformations previously described in connection with the FIG. 4 binder strip type. The deformations can be applied to adhesive band 38A, between points 46A and 46B of FIG. 2B. Although transverse curl in the other regions of the binder strip 34 presents less significant binding problems, these regions can also be provided with mechanical deformations and therefore, reduced curl there, as well.

The exact form and the number of mechanical deformations formed in the adhesive surface will vary, depending upon the type and thickness of the adhesive and the degree to which the curl is to be reduced. Mechanical deformations of sufficient degree so as to substantially reduce transverse curl, as compared to a binder strip that is not mechanically deformed, fall within the scope of one embodiment of the present invention. A substantial reduction is defined in the present application as a reduction of at least 20%. The degree of transverse curl can be quantified in accordance with the following equation:
Ct=H/W (1)
where Ct represents the amount of transverse curl, W is the distance along the substrate between the two relevant points of the binder strip as shown in FIG. 3, and H is the maximum degree of offset from the chord line X to the adhesive surface 30A. If the curl direction is reversed such that the two relevant points are below the adhesive surface, the value H should be considered negative.

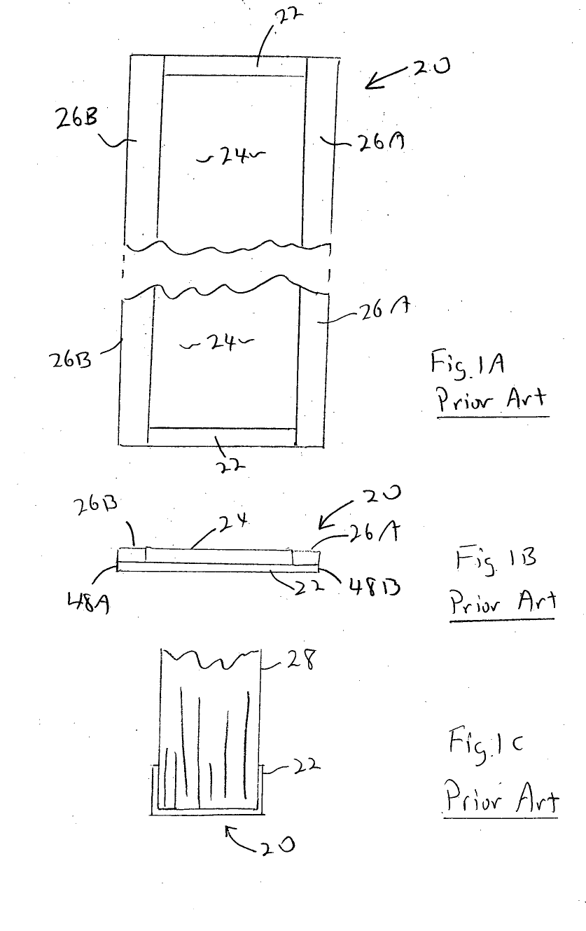

In equation (1) the distance W is unrelated to the amount of curl, while the distance H indicates the curl. Defining curl as a ratio in this manner provides a convenient way to compare amount of curl. In the case of the adhesive binder strip 20 of the type shown in FIGS. 1A and 1B, width W of equation (1) is the distance along the arc of the curl from point 48A to point 48B of the curled strip, and is also equal to the entire width of a flat binder strip. For adhesive binder strips 34 of the type shown in FIGS. 2A, 2B and 2C, the width W is the distance from point 46A to 46B (FIG. 2B) of the binder strip. Element 30B of the FIG. 3 diagram represents that part of the binder strip 34, which includes substrate section 36B (FIG. 2C) and the overlying adhesive, that is not included in the calculation for determining transverse curl.

As previously noted, the degree of transverse curl in a conventional binder strip has been found to increase over time from when the binder strip was manufactured. As also noted, the degree of curl is reduced significantly if the conventional binder strip is in roll form, but the curl will start to form once the binder strip is unrolled. When quantifying the amount of curl reduction, the base line is the amount of transverse curl that would be present in an untreated binder strip, one without mechanical deformations, otherwise having the same construction in terms of substrate and adhesive composition and dimensions as the treated binder strip. The amount of transverse curl in the baseline binder strip is measured seventy-two (72) hours after the binder strip is manufactured. During that time period, the baseline binder strip is in individual strip form, not in roll form, and is unrestrained by any weight or force. Also during the 72 hour period, the strip should be in an environment in which temperature is between 50 and 80 degrees F., and the relative humidity is between 20 and 80 percent. The percentage reduction in transverse curl is determined in accordance with the following equation:
Rc=[(Ctp−Cti)/Ctp]×100 (2)
where Rc is the percentage reduction in curl, Ctp is the amount of curl in the baseline strip in accordance with equation (1) and Cti is the amount of curl in the treated strip in accordance with equation (1).

By way of example, if a particular binder strip is manufactured using conventional methodology, the binder strip will develop a transverse curl Ctp measured at least 72 hours from the time of manufacture and assuming that the strip has been separated from adjacent strips so that there in nothing to inhibit the curling. Assume that the strip has a flat width W of 2.00 inches, and a value H of 0.30 inches. This results in a baseline curl value Ctp of 0.150 (H/W). Assume that an adhesive binder strip is made in accordance with the present invention, but having the same size substrate, substrate material and having adhesives of the same type and overall dimensions of the base line binder strip. Assume further that mechanical deformations are applied to the adhesives in accordance with the present invention so as to reduce the curl so that the value of H is reduced to 0.10 inches. This results in a curl value Cti of 0.050. Thus, according to equation (2), the reduction in curl Rc is 66.7%. As previously noted, a substantial reduction in curl is defined in the present application is a reduction Rc of at least 20%. It should be further noted that it is possible to apply sufficient mechanical deformation so as to cause the transverse curl Ct to reverse due to a negative value of H in equation (1). This will result in a value of Rc greater than 100%, a value that would fall within the present definition of substantial reduction as used in the present application.

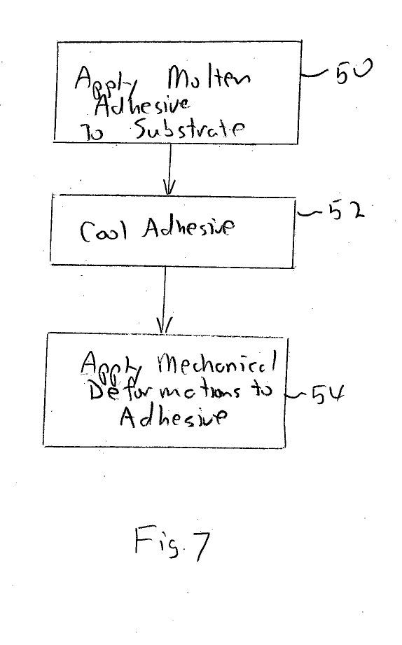

The method of the present invention is illustrated and can be summarized in the flow chart of FIG. 7. First, the heat activated adhesives, such as adhesive 24, 26A and 26B (FIG. 6A) are applied to the substrate 22 in molten form. This is represented by element 50 of the flow chart. As indicated by element 52 of the flow chart, the molten adhesive is cooled so that it is in the solid state. As previously described, for the purposes of the present application, the adhesive is sufficiently cooled, and is in a solid state as defined in the present application, when the temperature has dropped from the molten application temperature to the Mettler Softening Point, or below, for the adhesive in question. Once the adhesive is in the solid state, the mechanical deformations are applied to the adhesives as previously described.

Thus, a novel method of manufacturing an adhesive binder strip having reduced transverse curl has been disclosed together with the binder strip itself. Although various embodiments have been described in some detail, it is understood that various changes can be made by those skilled in the art without departing from the spirit and the scope of the present invention as defined by the appended claims.

1. A method of making an adhesive binder strip having a reduced transverse curl, said method comprising:
providing an elongated substrate having a longitudinal axis and transverse axis normal to the longitudinal axis;
applying a layer of molten, heated-activated adhesive over a surface of the substrate;
cooling the layer of molten adhesive so that the layer is in a solid state; and
subsequent to the cooling and prior to application of the binder strip to a stack to be bound, mechanically deforming a surface of the layer of adhesive to a degree such that curling of the binder strip along the transverse axis is substantially reduced.

2. An adhesive binder strip made in accordance with the method of claim 1.

3. The method of claim 1 wherein the mechanically deforming includes applying multiple grooves to the surface of the layer of adhesive.

4. An adhesive binder strip made in accordance with the method of claim 2.

5. The method of claim 3 wherein the multiple grooves are applied in a direction substantially parallel to the longitudinal axis of the binder strip.

6. An adhesive binder strip for binding a stack of sheets comprising:
an elongated substrate having a longitudinal axis and a transverse axis normal to the longitudinal axis; and
a layer of heat activated adhesive disposed on a surface of the substrate, with the layer having an exposed surface containing deformities of a sufficient magnitude to substantially reduce curling of the binder strip along the longitudinal axis.

7. The adhesive binder strip of claim 6 wherein the mechanical deformities include a multiplicity of grooves formed in the exposed surface.

8. The adhesive binder strip of claim 7 wherein the grooves extend at least 20% of the way through the total thickness of the adhesive layer.

9. The adhesive binder strip of claim 8 wherein the grooves are disposed in directions substantially parallel to the longitudinal axis.

10. The adhesive binder strip of claim 6 wherein the mechanical deformities include a multiplicity of punctures in the exposed surface.

11. A method of binding a stack of sheets using a binding machine, said method comprising:
providing an elongated substrate having a longitudinal axis and transverse axis normal to the longitudinal axis;
applying a layer of molten, heated-activated adhesive over a surface of the substrate;
cooling the layer of molten adhesive so that the adhesive layer is in a solid state;
mechanically deforming an exposed surface of the layer to an extent such that curling of the substrate about the transverse axis is substantially reduced, thereby forming a binder strip; and
subsequent to the mechanically deforming, applying the binder strip to a stack of sheets using a binding machine.

12. A binder strip formed in accordance with the method of claim 11.

13. A method of making an adhesive binder strip having a reduced transverse curl, said method comprising:
providing an elongated substrate having a longitudinal axis and transverse axis normal to the longitudinal axis;
applying a layer of molten, heated-activated adhesive over a surface of the substrate;
cooling the layer of molten adhesive so that the adhesive layer is in a solid state; and
subsequent to the cooling, forming a multiplicity of grooves in an exposed surface of the adhesive layer.

14. A binder strip made in accordance with the method of claim 13.

15. A method of making an adhesive binder strip having a reduced transverse curl, said method comprising:
providing an elongated substrate having a longitudinal axis and transverse axis normal to the longitudinal axis;
applying a layer of molten, heated-activated adhesive over a surface of the substrate;
cooling the layer of molten adhesive so that the adhesive layer is in a solid state; and
subsequent to the cooling, forming a multiplicity of punctures in an exposed surface of the adhesive layer.

16. A binder strip made in accordance with the method of claim 15.

17. A method of making an adhesive binder strip having a reduced transverse curl, said method comprising:
providing an elongated substrate having a longitudinal axis and transverse axis normal to the longitudinal axis;
applying a layer of molten, heated-activated adhesive over a surface of the substrate;
cooling the layer of molten adhesive so that the adhesive layer is in a solid state; and
subsequent to the cooling, forming a multiplicity of grooves in an exposed surface of the adhesive layer, with the grooves extending at least 20% of the way through the thickness of the adhesive layer.

18. A binder strip made in accordance with the method of claim 17.

19. An adhesive binder strip for binding a stack of sheets comprising:
an elongated substrate having a longitudinal axis and a transverse axis normal to the longitudinal axis; and
a layer of heat activated adhesive disposed on a surface of the substrate, with the layer having a multiplicity of grooves formed in an exposed surface which extend at least 20% of the way through a thickness of the layer of adhesive.
